(19) United States
(12) Patent Application Publication
(10) Pub. No.: US 2020/0051160 A1
(43) Pub. Date: Feb. 13, 2020

(54) NEGOTIATION PORTAL

(71) Applicant: Book With It, Inc., Irving, TX (US)

(72) Inventors: Lovkesh Kalia, Irving, TX (US); Hitesh Sharma, Irving, TX (US)

(21) Appl. No.: 16/228,215

(22) Filed: Dec. 20, 2018

Related U.S. Application Data
(60) Provisional application No. 62/716,414, filed on Aug. 9, 2018.

(51) Int. Cl. G06Q 30/08; G06Q 10/02; G06Q 30/06

(52) U.S. Cl. CPC G06Q 30/08; G06Q 30/0641; G06Q 10/02

(57) ABSTRACT

Aspects and features of a negotiating tool, system and methods are disclosed herein. In one aspect, there may be a negotiation tool comprising: at least one interface configured to communicate with at least one service provider of a service and a potential customer; and a processor configured to determine at least a first offer in response to a first bid received from the potential customer via the interface, wherein the first offer is determined based on at least a set of negotiating rules and pricing factors received from the at least one service provider via the interface; wherein the at least one interface is further configured to send the first offer to the potential customer in real time for acceptance

### CROSS-REFERENCE TO RELATED APPLICATION

This application claims benefit of U.S. provisional application Ser. No. 62/716,414, entitled “NEGOTIATION PORTAL”, filed on Aug. 9, 2018. The above-listed application is commonly assigned with the present application is incorporated herein by reference as if reproduced herein in its entirety.

### TECHNICAL FIELD

This application is directed, in general, to a negotiation portal and, more specifically, to a system and method for customers to negotiate directly with service providers and vendors via an online tool or mobile application (“app”) for services including lodging, travel, retail, and various other services that may be negotiated online.

### BRIEF DESCRIPTION

Reference is now made to the following descriptions taken in conjunction with the accompanying drawings, in which:

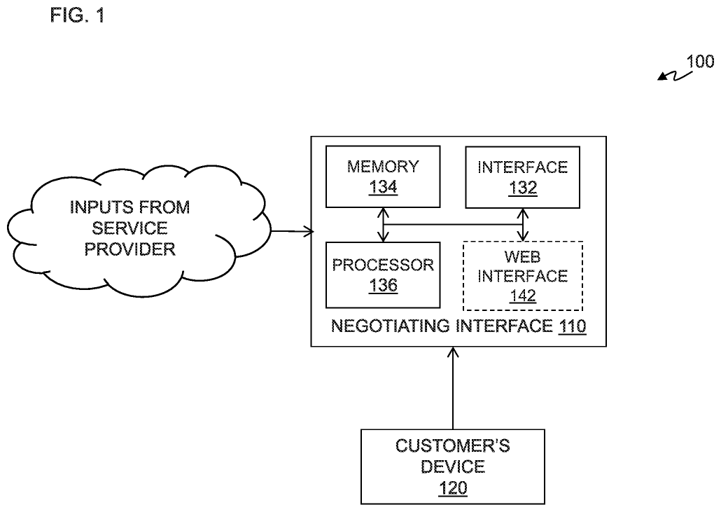

FIG. 1 illustrates a diagram of an embodiment of a negotiating system according to the principles of the disclosure;

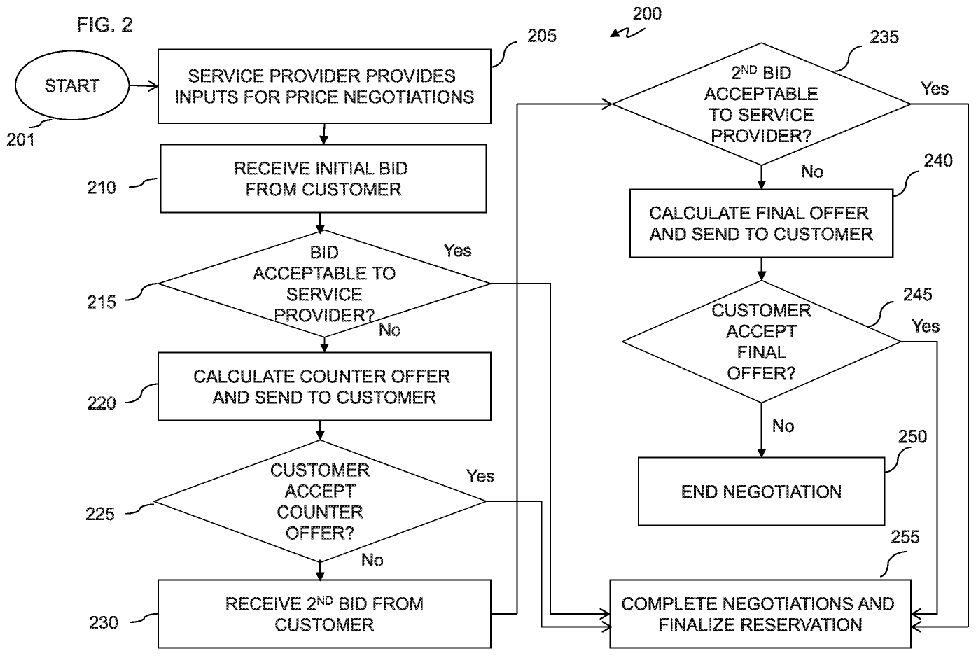

FIG. 2 illustrates a flow diagram of an embodiment of a method for negotiating according to principles of the disclosure;

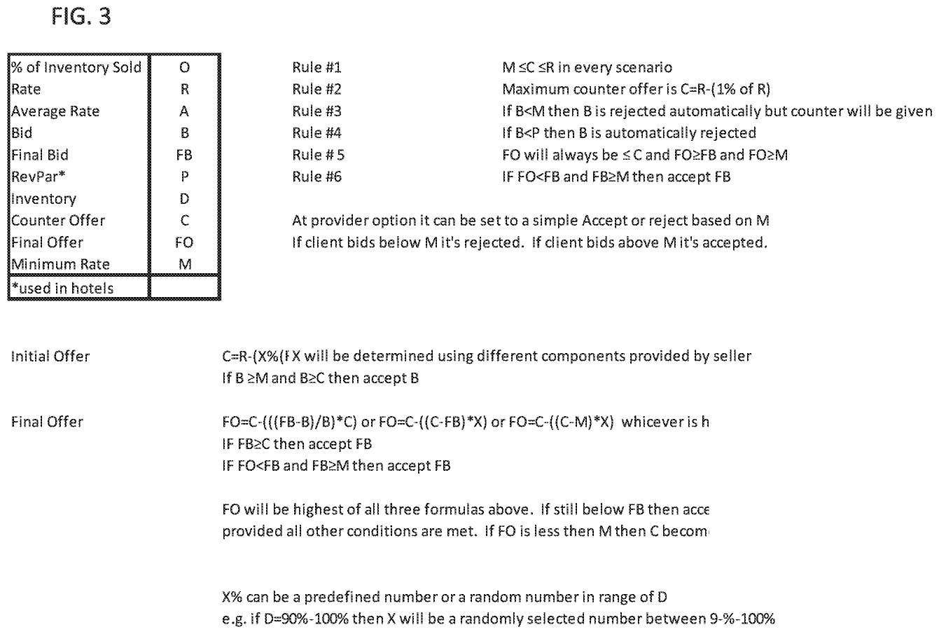

FIG. 3 represents definitions and rules that may be applied by the negotiating system; and

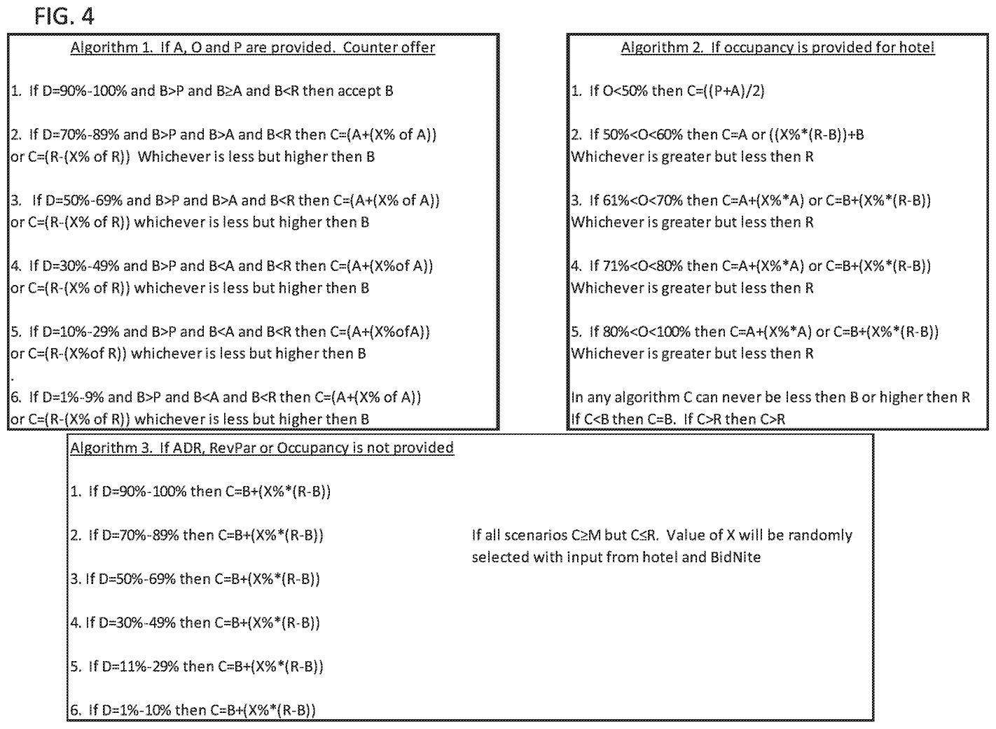

FIG. 4 represents examples of algorithms that may be applied during negotiations and implemented by the negotiation system.

### DETAILED DESCRIPTION

Customers wanting to find the best prices for travel often use discount search services provided by various websites and travel services. For example, one service for negotiating hotels and airfare asks the customer to submit a bid, suggesting a price, for an airline ticket. If the bid is accepted, the user's credit card is immediately charged and they are then given the details of the airline or hotel booking that they have “won.” In most cases, the user does not have control over at least the itinerary, number of stops or times of travel Likewise, a customer may bid on a hotel stay by suggesting a price for a hotel in a certain area. If the bidding site can meet the bid with any of their providers, the customer's credit card is automatically charged, without them having any review of the hotel, accommodations, or details of the offer. In addition, these travel bidding sites have restrictions on how often a customer can submit a bid.

Other methods for finding best prices may include calling, e-mailing, online chatting, or other human contact negotiations with a representative at a certain provider or travel coordinator. However, given the amount of factors, inputs, and options available for various travel services and providers, it is at least not reasonable to expect that a human is capable of and regularly does process such large amounts of data in their heads in the amount of time necessary to complete certain pricing negotiations.

What is needed is a service that allows customers to bid and negotiate directly with a service provider without having to rely on a “middle-man,”to assign travel and reservations without question. Disclosed herein is a negotiation system and pricing tool for customers to negotiate pricing directly with actual service providers for services such as, e.g., travel reservations and retail services via an online negotiation portal and tool. The negotiation system according to the disclosure is an improvement on previous reservation, negotiations system and pricing tools—customers have a choice and may consider, in some embodiments, multiple offers from a service provider, select their service provider, rates, and other factors before deciding to finalize their reservation and submit payment.

Providers may advantageously use the negotiation system and pricing tool according to the disclosure to sell and unload inventory, such as, e.g., unsold hotel rooms, without lowering certain rates, such as rack rates, or providing various other offers and promotions, which may be costly and time consuming. Potential customers may use the negotiation system at no cost to them, to obtain a better rate. Service providers may pay a fee to offer their services and negotiate pricing via the negotiation system, but the fee is minimal compared to the costs and resources previously necessary to adjust rates and promotions, etc.

The negotiation system and method according to the disclosure is an improvement over traditional human based negotiation systems and methods. It is not reasonable to expect a human employee to interact and/or negotiate with a customer in “real-time,” the time is takes a negotiation tool according to the disclosure to receive a bid and process an offer. In some embodiments, the real time for the negotiation tool according to the disclosure to process a bid, prepare an offer, and communicate the offer to the customer may in some cases be less than about 1 second, and in other embodiments, when processing a second or later bid, may be less than about 8 micro-seconds, and in some embodiments, may be about 5-7 micro-seconds. It would not reasonably be possible for a human to perform steps according to the disclosure in “real-time”—a human cannot physically process the received information and react with an offer or counter offer to the potential customer in less than a second, or even in less than about 10 micro-seconds, and in some examples, less than 7 micro-seconds.

Various terms and abbreviations may be used herein. The following are a list of various terms and definitions:

Rate=R. Rate is the “going” rate for a room or service.

Average Rate=A is the average rate for a room or service.

Bid=B is the customer's bid, which in some embodiments, may be a first bid by the customer.

Final Bid=FB is the final bid at which the customer may secure the requested services, which in some embodiments may be a second bid.

RevPar (Revenue per available room)=P. RevPAR is used in the hotel industry to make an assessment regarding a hotel's operations and its ability to fill its available rooms at an average rate. An increase in a property's RevPAR means that its average room rate or its occupancy rate are increasing.

Occupancy=O. Occupancy is the available occupancy of a hotel or facility.

Inventory=D is the amount of available rooms or services, or seats if for travel services. In calculations, percent of inventory (% D) is used.

Counter Offer=C is the counter offer provided by a provider after receiving the customer's initial bid. In some embodiments, the counter offer may be a first offer calculated by a negotiation tool.

Final Offer=FO is the Final offer that the service provider may provide. In some cases, the FO may equal C, but there may in some cases be multiple rounds of bidding and counter offers. In some embodiments, the final offer may be a second offer.

Minimum Rate=M is the minimum rate at which the provider may offer a room or services.

Turning now to the figures, FIG. 1 illustrates a diagram of an embodiment of a negotiation system 100 constructed according to the principles of the disclosure. The negotiation system 100 is configured to allow service provider, such as a hotel, airline, travel company, and various other service providers and retailers to interface with the system 100 in order to enter various factors and information for negotiating services and pricing with a customer. For this example, providers in the hotel and lodging industry may provide at least rate, average rate, minimum rate, available inventory, occupancy, and RevPar by service date in order to negotiate pricing for a reservation for a requested date.

The negotiation system 100, in one embodiment, includes negotiation generator 110 having at least a first interface 132 for receiving one or more inputs from a user at the service provider. The system 100 also may also include a web interface 142 for communicating with a customer. The customer may use a mobile application (“app”) installed on a mobile communication device or may interface through an online negotiation website either on a mobile device or personal computing device. In some embodiments, the web interface 142 may be a component of interface 132.

The user at the service provider may use any computing device or interface configured to communicate with the negotiation generator 110 in order to provide inputs related to price negotiation and reservations. In one embodiment, the user at the service provider communicates with the negotiation generator 110 via a web-based log-in system. In another embodiment, the user may communicate via a mobile application.

The negotiation generator 110 may include at least one web interface 132, a memory 134 and a processor 136. The negotiation generator 110 or at least a portion thereof may be embodied as a series of operating instructions stored on a non-transitory computer-readable medium that direct the operation of a processor when initiated. The negotiation generator 110 may be stored on a single computer or on multiple computers. The various components of the negotiation generator 110 may communicate via wireless or wired conventional connections. A portion of the negotiation generator 110 may be located on a server and other portions of the content provider 110 may be located on a computing device or devices that are connected to the server via a network or networks. In some embodiments, the negotiation generator 110 may be housed on a network, or may be stored at another computer storage facility. In one embodiment, the negotiation generator 110 is implemented on a server that includes the necessary logic and memory to perform the functions disclosed herein. Accordingly, the negotiation generator 110 may also be a website hosted on a web server, or servers, and that is accessible via the World Wide Web. A Uniform Resource Locator (URL) may be used to access various webpages of the negotiation generator 110.

The interface 132 may be a component or device interface configured to couple the negotiation generator 110 to a user at a service provider and receive inputs therefrom. The memory 134 is configured to store the various software aspects related to the negotiation generator 110. Additionally, the memory 134 may be configured to store the various software aspects related to the negotiation generator 110. Additionally, the memory 134 may be configured to store a series of operating instructions that direct the operation of the processor 136 when initiated. In one embodiment, the memory 134 may be a non-transitory computer readable medium. The memory 134, in some embodiments, may be the memory of a server.

The processor 136 is configured to direct the operation of the negotiation generator 110. As such, the processor 136 includes the necessary logic to communicate with the interface 132 and the memory 134 and perform the functions described herein to facilitate negotiation communications with a customer based on a plurality of inputs received by the negotiation generator 110. The processor 136 may be part of a server.

A web interface 142 may be a second interface, or may be incorporated into interface 132. The web interface 142 is configured to communicate with a user, whether using an app or web interface on a mobile communication device, or using a web-based tool on a personal computing device.

FIG. 2 illustrates a flow diagram of one embodiment of a method for negotiating using the negotiation system 100 and using algorithms and rules presented herein below. In a step 201, the method starts. At a step 205, a service provider (Provider A) interfaces with the negotiation system 100 and provides the necessary information to negotiate pricing with customers. In one embodiment where the provider is a hotel or lodging services provider the information may include at least rate (R), average rate (A), RevPar (P), occupancy (O), inventory (D), and a minimum rate (M), inter alia.

At a step 210, a potential customer logs into the negotiation system 100 via a web portal and initiates negotiations by entering an initial bid. In some embodiments, the potential customer may be using a mobile app. Any potential customer may use the system to bid on services, a customer need only to create a free account, providing certain information, such as, e.g., name, address, e-mail address, phone number, and a credit card or other online payment method, such as PAYPAL®, GOOGLE PAY®, APPLE PAY®, and the like.

At a step 215, based on the information provided by Provider A, the negotiation system determines, based on rules and algorithms executed by processor 136, whether the initial bid provided by the customer is acceptable to Provider A. If so, then the method proceeds to a step 255 and completes the negotiations and initiated finalizing a reservation. When a reservation is completed, the provider may pay a fee to the system 100 for providing the negotiation services.

If the initial bid is not acceptable to Provider A, the method proceeds to step 220 wherein a counter offer is calculated and sent to the customer.

At a step 225, the customer may either accept the counter offer, or reject the counter offer. If the customer accepts the counter offer, the method proceeds to a step 255 and completes the negotiations and initiated finalizing a reservation. If the customer does not accept the counter offer, the customer may present a second bid, which is received by the system 100 at a step 230.

At a step 235, based on the information provided by Provider A, the negotiation system determines, based on rules and algorithms executed by processor 136, whether the second bid provided by the customer is acceptable to Provider A. If so, then the method proceeds to a step 255 and completes the negotiations and initiated finalizing a reservation. If the initial bid is not acceptable to Provider A, the method proceeds to step 240 wherein a final offer is calculated and sent to the customer.

At a step 245, the customer may either accept the final offer, or reject the final offer. If the customer accepts the counter offer, the method proceeds to a step 255 and completes the negotiations and initiated finalizing a reservation. If the customer does not accept the final offer, the negotiations end at step 250. The customer may then be re-routed to the initial search results.

In this example, the customer may only submit two bids within a 24 hour period to Provider A. They may also present offers to another provider within the same 24 hours, but may only submit two bids to each provider within a 24 hour period.

Below are various examples and algorithms which may be used for negotiating between a customer and a service provider according to principles of the negotiation system and negotiating method presented herein.

The following rules and algorithms presented in FIGS. 3 and 4 may apply in all negotiations:

Rule #1: M is less than or equal to C, which is less than or equal to R in every scenario (M≤C≤R).

Rule #2: Maximum counter offer is represented by the equation: C=R−(1% of R).

Rule #3 If B<M then B is rejected automatically but counter may be given.

Rule #4 If B<P then B is automatically rejected.

Rule #5 FO will always be ≤C and FO≥FB and FO≥M.

Rule #6 IF FO<FB and FB≥M, then accept FB.

After receiving an initial bid (B) from the customer, the Initial Counter Offer (C) may be determined according to the following equation and rules: C=R−(X % of (R−M)). X may be determined using different components provided by seller. If B≥M and B≥C, then accept B.

The Final Offer (FO) may be determined according to the following equation and rules: FO=C−(((FB−B)/B)*C) or FO=C−((C−FB)*X) or FO=C−((C−M)*X), whichever is higher.

If FB=C then accept FB. If FO<FB and FB>M then accept FB. If FB<M then FO=C−((C−M)*X %). X % may be a predefined number or a random number in range of D. For example, if D=90%-100% then X may be a randomly selected number between 90-100%. The Final Offer (FO) will be the highest of the foregoing. If FO is still less than FB, then the system may accept FB, provided all other conditions are met. If FO is less than M, then C becomes the Final Offer.

In one embodiment, the Provider may provide a simple accept or rejection amount such that no Counter offer or Final Offer is negotiated: B<X, B rejected; B>X, B accepted. Provider may provider an amount X wherein if the Bid (B) is less than X, then the bid is rejected. If Bid (B) is greater than X, then the bid is accepted. In one embodiment, the amount X may be equal to Minimum rate (M). In another embodiment, X may equal M plus a predetermined amount.

For certain examples, some factors and amounts may be known and some may not be known. The following, as shown and represented in FIG. 4, are three algorithms that represent when certain bids may be accepted and when certain offers, such as e.g., first/counter and second, or final, may be made. In any algorithm C may never be less then B or higher then R. If C<B then use C=B. If C>R then use C. In all examples X % may be a predefined number or a random number in range of D. For example, if D=90%−100% then X may be a randomly selected number between 90%-100%.

Algorithm 1 relates to counter offers (C) and bids (B) when Average Rate (A), Inventory (D), and RevPar (P) are provided.

1. If D=90%−100% and B>P, B≥A, and B<R then accept B.

2. If D=70%-89% and B>P and B>A and B<R then C=(A+(X % of A)) or C=(R−(X % of R)), whichever is less but higher then B.

3. If D=50%-69% and B>P and B>A and B<R then C=(A+(X % of A)) or C=(R−(X % of R)) whichever is less but higher then B.

4. If D=30%-49% and B>P and B<A and B<R then C=(A+(X %of A)) or C=(R−(X % of R)) whichever is less but higher then B.

5. If D=10%-29% and B>P and B<A and B<R then C=(A+(X % of A)) or C=(R−(X %of R)) whichever is less but higher then B.

6. If D=1%-9% and B>P and B<A and B<R then C=(A+(X % of A)) or C=(R−(X % of R)) whichever is less but higher then B.

Algorithm 2 relates to counter offer (C) when occupancy (O) is provided for hotel.

1. If 0<50% then C=((P+A)/2).

2. If 50%<O<60% then C=A or ((X %*(R−B))+B, Whichever is greater but less then R.

3. If 61%<O<70% then C=A+(X %*A) or C=B+(X %*(R−B)), Whichever is greater but less then R.

4. If 71%<O<80% then C=A+(X %*A) or C=B+(X %*(R−B)), Whichever is greater but less then R.

5. If 80%<O<100% then C=A+(X %*A) or C=B+(X %*(R−B)), Whichever is greater but less then R.

In any algorithm C may never be less then B or higher then R. If C<B then use C=B. If C>R then use C.

Algorithm 3 represents determining a Counter Offer (C) if Average Rate (A), Inventory (D), RevPar (P) or Occupancy (O) are not provided.

1. If D=90%-100% then C=B+(X %*(R−B)).

2. If D=70%-89% then C=B+(X %*(R−B)).

3. If D=50%-69% then C=B+(X %*(R−B)).

4. If D=30%-49% then C=B+(X %*(R−B)).

5. If D=11%-29% then C=B+(X %*(R−B)).

6. If D=1%-10% then C=B+(X %*(R−B)).

In all scenarios, C>M, but C<R. The value of X may be randomly selected with input from hotel and BidNite (a computer software product) or it may also be a predefined number.

The following are examples of a potential customer submitting a bid to a negotiation tool according to the disclosure, wherein the negotiation tool receives the bid, calculates a first offer and sends the first offer back to the potential customer in “real time,” wherein real time, as used herein, is the actual time it takes for the negotiation tool to receive a bid from a potential customer, prepare an offer, and return the offer to the potential customer for consideration. In one example, the tool may calculate a first offer, which is a counter offer and relay it to the potential customer. In one example, Hotel Provider A has a rate of $125, with a Minimum Rate of $119 and a Total Inventory of 20 rooms. Available Inventory for the nights requested is 17 rooms. The potential customer submits a first bid, which is a bid of $85. The negotiation interface of the negotiation tool receives the first bid and a processor of the negotiation tool runs Algorithm 2 to come up with a first offer to the potential customer, the first being a counter offer of $124.15 (response=>offer selection=false AND counter offer=124.15). The interface sends the first offer (counter offer) of $124.15 back to the potential customer for consideration. The real time taken to receive the first bid, calculate a first offer, in this example, counter offer, and send the first offer back to the customer is less than 1 second of time, in one example, about 0.000518 seconds. The customer receives the first offer (counter offer of $124.15) and submits a second bid of $105. The negotiation tool receives the offer and runs Algorithm 1 (response=>offer selection=false AND final offer=119.77) and computes a second offer, which is a final offer of $119.77. The real time to receive the second bid, calculate the second (and final) offer, and send the second offer back to the customer is less than 6 micro-seconds, in one example about 0.00005698204 seconds.

In a second example: Hotel Provider B has a Minimum Rate of $119 and a Total Inventory of 20 rooms. Available Inventory for the nights requested is 5. The potential customer's first offer is $85. The negotiation tool runs Algorithm 2 (response=>offer selection=false AND counter offer=124.75) and computes a first offer, a counter offer of $124.75. In this example, the real time to receive the offer, calculate a first (counter) offer, and send the first offer back to the customer is less than 1 second, in this example, about 0.000518 seconds. The customer rejects the first offer and submits a second bid of $105. The negotiation tool runs Algorithm 2 (response=>offer selection=false AND final offer=123.31) and calculates a second and final offer of $123.31. In this example, the real time to receive the second bid, calculate a second/final offer, and send the second/final offer back to the customer is less than about 8 micro-seconds, in one embodiment, about 0.00007033348 seconds.

The above-described systems and methods or at least a portion thereof may be embodied in or performed by various processors, such as digital data processors or computers, wherein the computers are programmed or store executable programs or sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods or functions of the system described herein.

Certain embodiments disclosed herein may further relate to computer storage products with a non-transitory computer-readable medium that have program code thereon for performing various computer-implemented operations that embody at least part of the apparatuses, the systems or carry out or direct at least some of the steps of the methods set forth herein. Non-transitory medium used herein refers to all computer-readable media except for transitory, propagating signals. Examples of non-transitory computer-readable medium include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Various embodiments of a negotiation system have been disclosed herein. In one embodiment, there may be an online negotiation system comprising at least one interface for receiving inputs from at least one service provider, a web interface for receiving bids from potential customers, a memory for storing algorithms and rules, and a processor configured to execute the algorithms and rules for facilitating price negotiations between the potential customers and at least one service provider.

In another embodiment, there may be a method for negotiating pricing between potential customers and at least one service provider. The method including providing a negotiation system according to the disclosure. Method further includes, receiving information from the at least one service provider, receiving an initial bid from a potential customer, determining whether the initial bid is acceptable to the service provider, calculating counter offer and presenting the counter offer to the customer, receiving an acceptance or rejection from the customer; and finalizing a reservation if the customer accepts the counter offer.

The method further includes receiving a second offer from the customer, determining if the second offer is acceptable to the service provider, preparing a final offer, and ending negotiations if the customer rejects the final offer, or finalizing a reservation if the customer accepts the final offer.

While the examples provided in the above disclosure have been related with service providers in the hotel and lodging industry, the negotiation system and method may also be applied to airline reservations, other travel services, retail, and various other services wherein a customer may want to negotiate directly with a service provider for pricing and deals.

Aspects disclosed herein include:

A. A negotiation tool comprising: at least one interface configured to communicate with at least one service provider of a service and a potential customer; and a processor configured to determine at least a first offer in response to a first bid received from the potential customer via the interface, wherein the first offer is determined based on at least a set of negotiating rules and pricing factors received from the at least one service provider via the interface; wherein the at least one interface is further configured to send the first offer to the potential customer in real time for acceptance;

B: A computer program product stored on a non-transitory computer readable medium that is configured to negotiate pricing with a potential customer by performing a method, comprising: receiving, at an interface, inputs from at least one service provider, the inputs including at least a set of negotiating rules and pricing factors; receiving at least a first bid from a potential customer; and determining at least a first offer in response to the first bid based on the inputs received from the at least one service provider, wherein the receiving at least a first bid and determining at least a first offer is executed in real time; and

C: A method for negotiating pricing with a potential customer, the method comprising: receiving, at an interface, inputs from at least one service provider, the inputs including at least a set of negotiating rules and pricing factors; receiving at least a first bid from a potential customer; and determining at least a first offer in response to the first bid based on the inputs received from the at least one service provider; wherein the receiving inputs and at least a first bid and the determining at least a first offer are performed on a processor stored on a non-transitory computer readable medium.

Aspects A, B, and C may have one or more of the following additional elements in combination:

Element 1: wherein the first offer is a counter-offer;

Element 2: wherein the at least one interface is configured to receive a second bid from the potential customer;

Element 3: wherein the processor is further configured to determine at least a second offer in response to the second bid received from the potential customer via the interface, wherein the second offer is determined based on at least the set of negotiating rules and pricing factors received from the at least one service provider, and wherein the interface is configured to send the second offer to the potential customer for acceptance;

Element 4: wherein the second offer is a second counter-offer, an acceptance of the second bid, or a rejection of the second bid;

Element 5: wherein the first offer is an acceptance of the first bid;

Element 6: wherein the first offer is a rejection of the first bid;

Element 7: wherein the processor is configured to determine the first offer in less than 1 second of time;

Element 8: wherein the processor is configured to determine the second offer in less than about 8 micro-seconds of time; and

Element 9: wherein the method further includes sending the first offer to the potential customer for acceptance.

Those skilled in the art to which this application relates will appreciate that other and further additions, deletions, substitutions and modifications may be made to the described embodiments.

1. A negotiation tool comprising:
at least one interface configured to communicate with at least one service provider of a service and a potential customer; and
a processor configured to determine, in real time, at least a first offer in response to a first bid received from the potential customer via the interface, wherein the first offer is determined based on at least a set of negotiating rules and pricing factors received from the at least one service provider via the interface, wherein the pricing factors include at least rate, average rate, minimum rate, available inventory, occupancy, and revenue per available room (RevPar);
wherein the at least one interface is further configured to send the first offer to the potential customer in real time for acceptance;
wherein real time is less than 1 second.

2. The negotiation tool according to claim 1, wherein the first offer is a counter-offer.

3. The negotiation tool according to claim 2, wherein the at least one interface is configured to receive a second bid from the potential customer.

4. The negotiation tool according to claim 3, wherein the processor is further configured to determine at least a second offer in response to the second bid received from the potential customer via the interface, wherein the second offer is determined based on at least the set of negotiating rules and pricing factors received from the at least one service provider, and wherein the interface is configured to send the second offer to the potential customer for acceptance.

5. The negotiation tool according to claim 4, wherein the second offer is a second counter-offer, an acceptance of the second bid, or a rejection of the second bid.

6. The negotiation tool according to claim 1, wherein the first offer is an acceptance of the first bid.

7. The negotiation tool according to claim 1, wherein the first offer is a rejection of the first bid.

8. The negotiation tool according to claim 1, wherein the processor is configured to determine the first offer in less than about 6 microseconds.

9. A computer program product stored on a non-transitory computer readable medium that is configured to negotiate pricing with a potential customer by performing a method, comprising:
receiving, at an interface, inputs from at least one service provider, the inputs including at least a set of negotiating rules and pricing factors, wherein the pricing factors include at least rate, average rate, minimum rate, available inventory, occupancy, and revenue per available room (RevPar);
receiving at least a first bid from a potential customer; and
determining, in real time, at least a first offer in response to the first bid based on the inputs received from the at least one service provider;
wherein the receiving at least a first bid and determining at least a first offer is executed in real time, wherein real time is less than 1 second.

10. The computer program product according to claim 9, wherein the method further includes sending the first offer to the potential customer for acceptance.

11. The computer program product according to claim 9, wherein the first offer is a counter-offer.

12. The computer program product according to claim 11, wherein the interface is configured to receive a second bid from the potential customer.

13. The computer program product according to claim 12, wherein the method further includes determining at least a second offer in response to the second bid received from the potential customer via the interface, wherein the second offer is determined based on the inputs received from the at least one service provider, and wherein the interface is configured to send the second offer to the potential customer for acceptance.

14. The computer program product according to claim 13, wherein the second offer is a second counter-offer, an acceptance of the second bid, or a rejection of the second bid.

15. The computer program product according to claim 9, wherein the first offer is an acceptance of the first bid.

16. The computer program product according to claim 9, wherein the first offer is a rejection of the first bid.

17. The computer program product according to claim 9, wherein the determining the first offer is accomplished by the computer program product in less than about 6 microseconds.

18. A method for negotiating pricing with a potential customer, the method comprising:
receiving, at an interface, inputs from at least one service provider, the inputs including at least a set of negotiating rules and pricing factors, wherein the pricing factors include at least rate, average rate, minimum rate, available inventory, occupancy, and revenue per available room (RevPar);
receiving at least a first bid from a potential customer; and
determining, in real time, at least a first offer in response to the first bid based on the inputs received from the at least one service provider;
wherein the receiving inputs and at least a first bid and the determining at least a first offer are performed on a processor stored on a non-transitory computer readable medium and performed in less than 1 second.

19. The method according to claim 18, wherein the method further includes sending the first offer to the potential customer for acceptance.

20. The method according to claim 18, wherein the first offer is a counter-offer, and the method further includes:
receiving a second bid from the potential customer; and
determining at least a second offer in response to the second bid received from the potential customer via the interface, wherein the second offer is determined based on the inputs received from the at least one service provider, and wherein the interface is configured to send the second offer to the potential customer for acceptance.
